(19) United States
(12) Patent Application Publication
(10) Pub. No.: US 2025/0205856 A1
(43) Pub. Date: Jun. 26, 2025

(54) Hand-Held Power Tool

(71) Applicant: Robert Bosch GmbH, Stuttgart (DE)

(72) Inventor: Simon Wechsler, Esslingen (DE)

(21) Appl. No.: 18/979,945

(22) Filed: Dec. 13, 2024

(30) Foreign Application Priority Data
Dec. 21, 2023 (DE) 10 2023 213 142.0

(51) Int. Cl. B25B 21/00; B25B 23/18; B25F 5/00; B25F 5/02

(52) U.S. Cl. CPC B25B 21/00; B25B 23/18; B25F 5/001; B25F 5/02

(57) ABSTRACT

A hand-held power tool having a housing, with an electrically commutated drive motor including a drive shaft and substantially arranged within the housing, with a control unit at least for controlling the drive motor comprising a control unit board, and with a worksite lighting unit for lighting a worksite, is disclosed. It is proposed that the worksite lighting unit is arranged at an angle to the control unit board.

This application claims priority under 35 U.S.C. § 119 to application no. DE 10 2023 213 142.0, filed on Dec. 21, 2023 in Germany, the disclosure of which is incorporated herein by reference in its entirety.

The present disclosure relates to a hand-held power tool.

### BACKGROUND

A hand-held power tool with a drive motor, with a transmission and a control unit is already known from DE 10 2018 206 876 A1.

### SUMMARY

The present disclosure proceeds from a hand-held power tool having a housing, with an electrically commutated drive motor comprising a drive shaft and substantially arranged within the housing, with a control unit at least for controlling the drive motor comprising a control unit board, and with a worksite lighting unit for lighting a worksite. It is proposed that the worksite lighting unit is arranged at an angle to the control unit board.

The disclosure provides a hand-held power tool in which robustness is increased. In addition, illumination of the worksite is allowed to be increased while shading is reduced, in particular minimized. In addition, the disclosure reduces manufacturing costs.

The hand-held power tool can be configured as an electrically operated hand-held power tool. The electrically operated hand-held power tool can be configured as a mains-operated or a cordless hand-held power tool. For example, the hand-held power tool can be designed as a screwdriver, a drill screwdriver, a rotary impact screwdriver, a hammer, a drill hammer or an impact drill screwdriver.

The housing of the hand-held power tool is configured to at least partially receive the drive motor, the control unit, the control unit board, and the worksite lighting unit. The housing can be configured as a shell housing with two half shells.

The hand-held power tool can have a tool holder. The tool holder can be configured as an internal tool holder, for example a bit holder, and/or as an external tool holder, for example a socket holder. It is also conceivable that the tool holder is configured as a drill chuck. The tool holder can accommodate insert tools, such as screwdriver bits or sockets, so that a user can produce screw connections between a fastening element and a fastener holder.

The hand-held power tool has a drive unit. The drive unit comprises the electrically commutated drive motor and one transmission. In particular, the drive motor can be designed as at least one electric motor. The transmission can be configured as at least one planetary gear, wherein it can, for example, be shiftable. The planetary gear can comprise at least one planetary carrier and planetary wheels. In addition, the transmission, in particular the planetary gear, can comprise a ring gear. In the case of a shiftable transmission, it is possible to switch between at least two gear stages by means of at least one gear shifting element, in particular a gear shifter. The drive motor is configured such that it can be actuated via a manual switch. When the manual switch is actuated by a user, the drive motor is switched on and the hand-held power tool is put into operation. If the manual switch is not further actuated by the user, the drive motor is switched off. The drive motor can preferably be electronically controlled and/or regulated in such a way that a reversing mode and a specification for a desired rotational speed can be implemented. In reversing mode, the drive motor can be switched between a clockwise direction of rotation and a counterclockwise direction of rotation. To switch the drive motor in reversing mode, the hand-held power tool can comprise a rotation direction switching element, in particular a rotation direction changeover switch.

The hand-held power tool can comprise a percussion mechanism. The percussion mechanism generates high torque peaks during operation to loosen tight connecting means or to fasten connecting means or drill holes. The percussion mechanism can be connected to the drive motor by means of the transmission. The percussion mechanism can, e.g., be designed as a rotary percussion mechanism, a detent percussion mechanism, a rotary percussion mechanism, or a hammer percussion mechanism.

The drive motor comprises the drive shaft. The drive shaft is mounted in the housing via at least one drive shaft bearing. The drive motor can actuate the transmission, the percussion mechanism and/or the tool holder by means of the drive shaft. The drive shaft bearing can be configured as a ball bearing, a rolling bearing or a sliding bearing, for example. The drive shaft bearing can be arranged at an end of the drive motor facing the tool holder. The drive shaft bearing can be arranged, in particular axially, between the transmission and the drive motor. A further drive shaft bearing can also be provided to support the drive shaft. The further drive shaft bearing is arranged at the end of the drive motor facing away from the tool holder. The further drive shaft bearing can be configured as a ball bearing, a rolling bearing or a sliding bearing, for example. The hand-held power tool can have a tool axis. In this case, an axis of rotation of the drive shaft can form the tool axis. “Axial” is in particular intended to be understood as substantially parallel to the tool axis. Whereas “radial” is intended to be understood as substantially perpendicular to the tool axis.

The transmission comprises a transmission cover that at least partially closes the transmission. The transmission cover can be arranged between the tool holder and the drive motor. The transmission cover can be arranged axially between the at least one planetary gear stage and the drive motor. The transmission cover can receive the ring gear of the transmission, in particular the planetary gear. The ring gear and the transmission cover can be connected to one another in a form-locking, force-locking and/or material-locking manner. The hand-held power tool may comprise a torque coupling. The torque coupling can be configured to be adjustable, wherein the user can adjust desired torques by means of an adjustment ring. The torque coupling is configured to trigger when the desired torque is achieved. The torque coupling can be arranged axially between the tool holder and the transmission. The gear cover can be arranged, in particular axially, between the torque coupling and the drive motor. The hand-held power tool can comprise a spindle lock device. The spindle lock device is configured to block the tool holder from torques applied from the outside to the tool holder.

The hand-held power tool further includes a power supply, wherein the power supply is provided for cordless operation by means of rechargeable batteries, in particular hand-held power tool rechargeable battery packs, and/or for mains operation. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell can, for instance, be configured as a Li-ion battery cell having a nominal voltage of 3.6 V. The hand-held power tool rechargeable battery pack can include up to ten battery cells, for example, although a different number of battery cells is conceivable too. Both an embodiment as a cordless hand-held power tool and operation as a mains-operated hand-held power tool are sufficiently well-known to those skilled in the art, so the specifics of the power supply will not be discussed here.

The hand-held power tool comprises a control unit at least for controlling the drive motor. For this purpose, the control unit is connected for signal exchange to the drive motor. The control unit can be arranged in the housing. For example, the control unit can be arranged in a handle of the hand-held power tool, in a region of a power supply interface or, in particular radially, between the drive shaft and the manual switch. The control unit board can comprise electronic components for control and/or signal processing, for example capacitors, transistors, resistors and/or at least one processor or microprocessor. The control unit can comprise a sensor board. The sensor board can be connected to the control unit board for sensor-controlled commutation of the drive motor. The sensor board and the control unit board can, for example, be connected to each other by cable. For example, the sensor board and the control unit board can be connected to each other by means of at least one connector and one coupling. The sensor board can be arranged in the housing between the drive motor and the tool holder. The sensor board can have at least one sensor element, such as a Hall sensor. For example, three sensor elements can be provided on the sensor board. The control unit is designed to control and/or regulate the drive motor depending on signals from the sensor board. The control unit can receive the signals from the sensor board and switching signals from the manual switch. It is conceivable that the control unit processes the switching signals from the manual switch before the control unit forwards the switching signals to the drive unit for control. The control unit is designed to process the signals from the sensor board and the switching signals such that the drive unit, in particular the drive motor, can be controlled and/or regulated as required. The control unit can comprise at least one microprocessor or a microcontroller.

The hand-held power tool comprises the worksite lighting unit for lighting the worksite. The worksite lighting is configured to illuminate the worksite such that a user can perform work on the worksite illuminated. The worksite can be arranged at least partially in the housing. The worksite lighting unit is arranged at an angle to the control unit board in the housing. The worksite lighting unit and the control unit board are at an angle to each other, which may be at an angle range of 5° to 90° inclusive. The worksite lighting unit can be arranged radially, in particular to the tool axis, offset from the tool holder to reduce, in particular minimize, shading in front of the tool holder.

In one embodiment of the hand-held power tool, the worksite lighting comprises a worksite lighting board arranged at an angle to the control unit board. The worksite lighting unit comprises the worksite lighting board, at least one light source, such as an LED, and/or at least one light guiding element, such as a lens or light guide. The light guiding element is configured to direct emitted light from the light source towards the worksite. The light source can abut the light guiding element. The light source can be arranged on and mechanically and/or electrically connected to the worksite lighting board. It is possible that a plurality of light sources and/or a plurality of light guiding elements is provided, for example two or three, or more than three. The worksite lighting board and the control unit board can be arranged within an angular range of 5° to 90° inclusive of each other. The control unit board can be arranged radially, in particular to the tool axis, between the drive shaft and/or the tool axis and the worksite lighting unit, in particular the light source. The light source can be arranged radially to the tool axis between the control unit board and the manual switch.

In one embodiment of the hand-held power tool, the worksite lighting unit at least partially abuts the control unit board. The worksite lighting unit can at least partially abut the control unit board using the worksite lighting board. It is possible that the worksite lighting unit may abut the control unit board over a large area, for example over an entire width of the control unit board. The worksite lighting unit and the control unit board may be soldered together, inserted into one another, clamped together, jammed together, or connected by means of a plug and a coupling. This avoids the need for additional cables or other transitional connections.

In one embodiment of the hand-held power tool, the control unit board is arranged substantially parallel to the drive shaft in the housing. The control unit board can have an angle within an angle range of up to 15° relative to the drive shaft. The control unit board can be arranged in the housing tilted relative to the tool axis. The control unit board can be received and arranged by at least one receptacle in the housing.

In one embodiment of the hand-held power tool, the worksite lighting unit comprises at least one abutment element for abutment on the control unit board. For example, the abutment element may be as at least a shoulder, a section, a web, an edge, or a protrusion. It is possible for a plurality of abutment elements to be provided, such as two, three or four. It is further contemplated that the light source is arranged substantially between two abutment elements. It is further possible that two abutment elements are arranged opposite one another. The abutment element can be arranged at least partially on the control unit board. The abutment element is configured such that stability is increased when the control unit board is connected to the worksite lighting board. In this case, the abutment element abuts the control unit circuit board in order to increase the stability of the worksite lighting unit and to avoid tilting. Furthermore, the abutment element allows a depth stop for the worksite lighting board.

In one embodiment of the hand-held power tool, the control unit board comprises a worksite lighting receptacle configured to at least partially receive the worksite lighting unit. The worksite lighting receptacle can be configured according to a type of slit, opening, recess, shaft, canister, shell, web, coupling, protrusion, or edge. In so doing, the worksite lighting receptacle can be slit-like, round, elliptical, or polygonal shaped. The control unit board can form the worksite lighting receptacle such that it is integral. The worksite board may be electrically connected and/or connected for signal exchange to the control unit board, such that the worksite lighting board forwards energy from the energy supply to the worksite lighting unit, in particular the light source.

In one embodiment of the hand-held power tool, the worksite lighting unit comprises at least one connecting element for connection to the control unit board. For example, the connecting element for the control unit board can be configured according to a type of plug, pin, web, mandrel, or pin. The connecting element is configured to connect the worksite lighting unit for signal exchange to the control unit board. For example, the connecting element can engage or at least partially engage in the control unit board. The connecting element for the control unit board is configured to form a mechanical and/or electrical connection with the worksite lighting receptacle in order to connect the worksite lighting board and the control unit board to each other. For example, the control unit board and the worksite lighting board can be plugged, soldered, or glued together.

In one embodiment of the hand-held power tool, the control unit comprises at least one orientation element configured to align the worksite lighting unit relative to the control unit board. The control unit board can form the orientation element. The orientation element can also align the worksite lighting board relative to the tool axis. For example, the orientation element can be formed according to a type of slot, opening, canister, coupling, plug, groove, web, protrusion, mandrel, edge, or recess. The orientation element and the worksite lighting receptacle can be integral. It is also possible that the worksite lighting receptacle can be formed by the worksite lighting board. Furthermore, it is possible that the orientation element is formed by the worksite lighting board.

In one embodiment of the hand-held power tool, the orientation element is configured to position the worksite lighting unit transversely to the drive shaft. The orientation element locates the worksite lighting board transversely, in particular substantially perpendicular, to the drive shaft and the tool axis. If the plurality of light sources is provided, the orientation element can also arrange the plurality of light sources transversely to the tool axis, wherein a radiating direction of the light sources may be substantially parallel to the tool axis.

In one embodiment of the hand-held power tool, the orientation element is configured to position the worksite lighting unit substantially parallel to the drive shaft. The orientation element may arrange the worksite lighting board substantially parallel to the drive shaft or tool axis.

### BRIEF DESCRIPTION OF THE DRAWINGS

The disclosure is explained in the following with reference to preferred embodiments. In the following, the drawings show:

FIG. 1 a schematic view of a hand-held power tool according to the disclosure;

FIG. 2 a section of a longitudinal cross-section of the hand-held power tool;

FIG. 3 a perspective view of a first embodiment of a control unit having a worksite lighting unit of the hand-held power tool;

FIG. 4a a cross-sectional view of a second embodiment of the control unit with the worksite lighting unit of the hand-held power tool; and

FIG. 4b a cross-sectional view of the second embodiment of the control unit with the worksite lighting unit of the hand-held power tool

### DETAILED DESCRIPTION

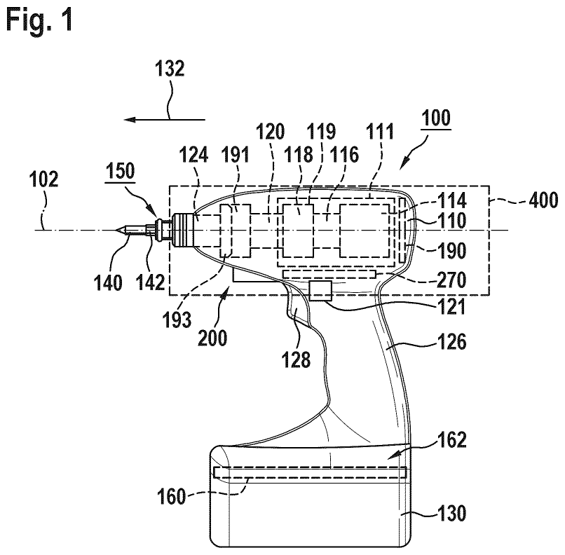

FIG. 1 shows a hand-held power tool 100 according to the disclosure that is designed as a screwdriver 100. The hand-held power tool 100 comprises an output shaft 124 and a tool holder 150. The hand-held power tool 100 comprises a housing 110 with a handle 126. To provide a mains-independent power supply, the hand-held power tool 100 can be mechanically and electrically connected to a power supply for cordless operation, so that the hand-held power tool 100 is configured as a cordless hand-held power tool 100. A hand-held power tool rechargeable battery pack 130 is used here as the power supply. The present disclosure is not limited to cordless hand-held power tools, however, but can also be used for mains-dependent, i.e. mains-operated, hand-held power tools.

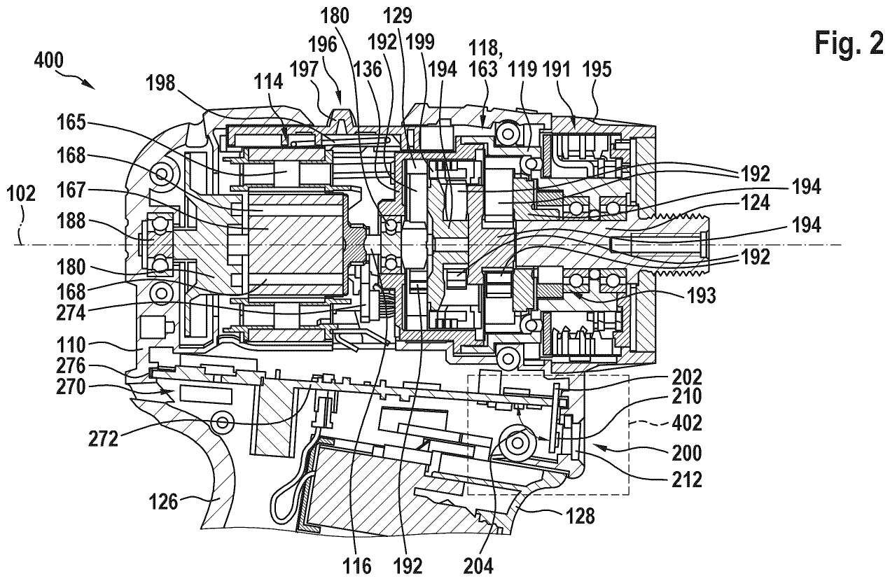

The housing 110 comprises a drive unit 111. The power unit 111 is arranged in the housing 110. The drive unit 111 comprises an electrically commutated drive motor 114, which is supplied with power by the hand-held power tool rechargeable battery pack 130, and a transmission 118. The drive motor 114 comprises a stator 165 and a rotor 167 with rotor magnets 168; see also FIG. 2. The transmission 118 is designed as at least one planetary gear 163. The drive motor 114 is designed such that it can be actuated, for example via a manual switch 128, so that the drive motor 114 can be switched on and off. The drive motor 114 can advantageously be electronically controlled and/or regulated, so that a reversing mode and a desired rotational speed can be implemented. For the reversing mode, the hand-held power tool 100 comprises a rotation direction switching element 121 configured as a rotation direction changeover switch. The rotation direction switching element 121 is configured to switch the drive motor 114 between a clockwise direction of rotation and a counterclockwise direction of rotation. The design and mode of operation of a suitable drive motor are sufficiently well-known to those skilled in the art, which is why they will not be discussed in more detail here.

The transmission 118 is connected to the drive motor 114 via a drive shaft 116. The drive shaft 116 is mounted in the housing 110 by means of a drive shaft bearing 180 and a further drive shaft bearing 188. The transmission 118 is intended to convert a rotation of the drive shaft 116 into a rotation between the transmission 118 and the tool holder 150. The transmission 118 comprises a transmission housing 119, which is arranged in the housing 110. The transmission 118 includes at least one ring gear 129, planetary wheels 192, and planetary carriers 194, wherein the planetary carriers 194 rotatably support the planetary wheels 192. The planetary wheels 192 engage in the ring gear 129. Furthermore, the transmission 118 includes a transmission cover 136 that closes the transmission 118 at least in sections, see also FIG. 2. The transmission cover 136 receives the ring gear 129 of the transmission 118. The transmission cover 136 is cup-like as an example, see FIG. 2. The transmission 118 is configured here as a shiftable transmission 118 that can be shifted between at least two gear stages by means of at least one gear shifting element 196, see also FIG. 2. The gear shifting element 196 includes a gear shifter 197, a shift clasp 198, and a shifting ring gear 199. The shifting clasp 198 is configured to engage with and axially displace the shifting ring gear 199. The hand-held power tool 100 herein includes, by way of example, a torque coupling 191 and a spindle lock device 193. The torque coupling 191 is configured to be adjustable by means of an adjustment ring 195, see also FIG. 2. The torque coupling 191 is arranged axially between the tool receptacle 150 and the transmission 118. The spindle lock device 193 is axially arranged between the tool receptacle 150 and the transmission 118. Further, the hand-held power tool 100 comprises a fan impeller 190. The fan impeller 190 is intended to generate an air flow in the housing 110. The hand-held power tool 100 comprises a hand-held power tool axis 102, wherein an axis of rotation of the drive shaft 116 forms the hand-held power tool axis 102.

The tool holder 150 is provided on the output shaft 124. The tool holder 150 is preferably molded onto and/or configured on the output shaft 124. The tool holder 150 is preferably arranged in an axial direction 132 facing away from the drive unit 111. The tool holder 150 is configured here as a hexagon socket, in the form of a bit holder, which is provided to accommodate an insert tool 140. Only the output shaft 124 without the tool holder 150 is shown in FIG. 2. The insert tool is configured in the form of a screwdriver bit with a polygonal external coupling 142. The type of the screwdriver bit, for example HEX type, is sufficiently well-known to those skilled in the art. The present disclosure is not limited to the use of HEX screwdriver bits, however; other tool holders that appear useful to the those skilled in the art, such as HEX drills, SDS quick-insert tools, sockets or round-shank drill chucks, can be used as well. The design and functioning of a suitable bit holder are sufficiently well-known to those skilled in the art as well.

The hand-held power tool 100 comprises a control unit 270 at least for controlling the drive unit 111, in particular the drive motor 114. The control unit 270 comprises a control unit board 272 and a sensor board 274 for sensor-controlled commutation of the electrically commutated drive motor 114, see also FIG. 2. Both the control unit board 272 and the sensor board 274 are arranged within the housing 110. The sensor board 274 is arranged between the drive motor 114 and the transmission 118. The control unit board 272 is arranged radially between the drive unit 111 and the rotation direction selector switch 121. The sensor board 274 and the control unit board 272 are wired together, where wiring is not shown in FIG. 2. The sensor board 274 includes Hall sensors. The housing 110 also comprises a power supply holding device 160. The power supply holding device 160 accommodates the hand-held power tool rechargeable battery pack 130 and forms a base 162 comprising a standing surface. The hand-held power tool rechargeable battery pack 130 can be released from the power supply holding device 160 without tools. The housing 110 also comprises the handle 126 and the power supply holding device 160. The handle 126 can be grasped by a user. In one embodiment, the power supply holding device 160 is arranged on the handle 126. The hand-held power tool 100 can be set down on the base 162.

The hand-held power tool 100 comprises a worksite lighting unit 200 for lighting a worksite, wherein the worksite lighting unit 200 is arranged at an angle to the control unit board 272, see also FIGS. 2-4. The worksite lighting unit 200 is arranged at least partially in the housing 110. The worksite lighting unit 200 and the control unit board 272 comprise an angle within a range from 5° to 90° inclusive, see also FIGS. 2-4.

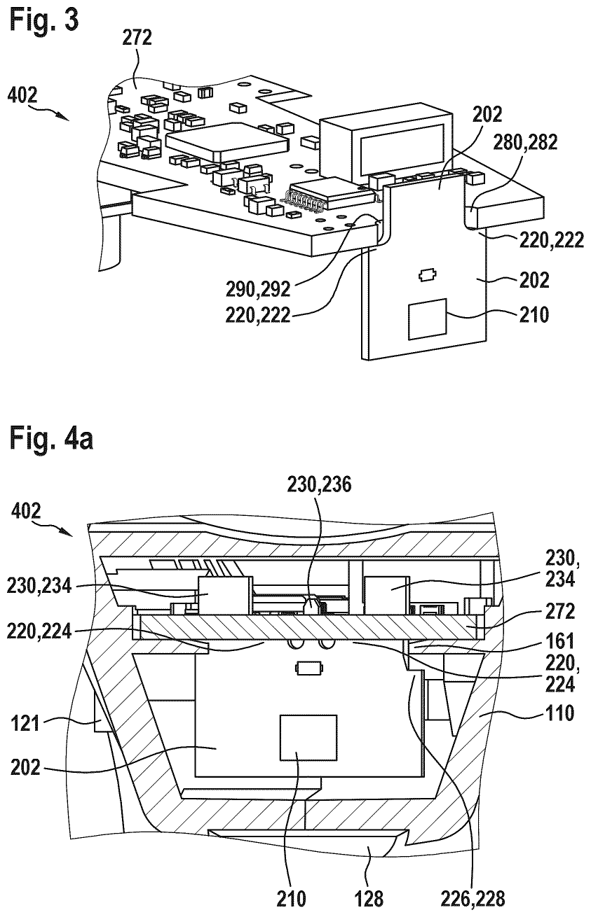

FIG. 2 shows a section 400 of a longitudinal section of the hand-held power tool 100. The control unit 270 and the worksite lighting unit 200 are connected for signal exchange to each other, and wiring is not shown. The worksite lighting 200 comprises a worksite lighting board 202. The worksite lighting board 202 is arranged at an angle to the control unit board 272. Furthermore, the worksite lighting unit 200 comprises a light source 210, such as an LED, and a light guiding element 212, such as a lens. The light guiding element 212 is provided to direct emitted light from the light source 210 towards the worksite. The light source 210 is arranged on the worksite lighting board 202, see also FIGS. 3-5. The light source 210 is mechanically and electrically connected to the worksite lighting board 202. The worksite lighting board 202 and the control unit board 272 are arranged at an angle 204 within an angle range of 5° to 90° to each other. The light source 210 is arranged radially to the tool axis 102 between the control unit board 272 and the manual switch 128. The worksite lighting unit 200 abuts at least partially the control unit board 272 by means of the worksite lighting board 202. The control unit board 272 is arranged substantially parallel to the drive shaft 116 in the housing 110. Here, an angle between the control unit board 272 and the drive shaft is within a range of up to 15°. The control unit board 272 is arranged relative to the tool axis 102 tilted within the housing 110. The housing 110 includes a receptacle 276 for the control unit board 272. The receptacle 276 for the control unit board 272 receives the control unit board 272 at least in a form-fitting manner and locates the control unit board 272 in the housing 110.

FIG. 3 shows a perspective view of a first embodiment of the control unit 270 with the worksite lighting unit 200 of the hand-held power tool 100, wherein a cut-out 402 shown. The worksite lighting board 202 and the control unit board 272 are soldered together. The worksite lighting unit 200, in particular the worksite lighting board 202, includes at least one abutment element 220 for abutment to the control unit board 272. For example, two abutment elements 220 are formed as shoulders 222 here. The shoulders 222 each abut the control unit board 272. The light source 210 is arranged substantially between the shoulders 222, wherein the two shoulders are arranged opposite to each other. The control unit board 272 includes a worksite lighting receptacle 280. The worksite lighting receptacle 280 is provided to at least partially receive the worksite lighting unit 200, in particular the worksite lighting board 202. Here, the worksite lighting receptacle 280 is formed as a recess 282. The worksite lighting unit 200 includes at least one connection element 230 for connection to the control unit board 272. Here, the connection element 230 for the control unit board 272 is formed in the manner of a web 232. The coupling element 230 partially engages with the control unit board 272. The coupling element 230 is integral with the worksite lighting board 202. The control unit 270 includes at least one orientation element 290. The orientation element 290 is provided to align the worksite lighting unit 200 relative to the control unit board 272. The control unit board 272 forms the orientation element 290. Here, the orientation element 290 is shaped like a recess 292. The orientation element 290 and the worksite lighting receptacle 280 are integral herein. The orientation element 290 is provided to arrange the worksite lighting unit 200 transversely to the drive shaft 116.

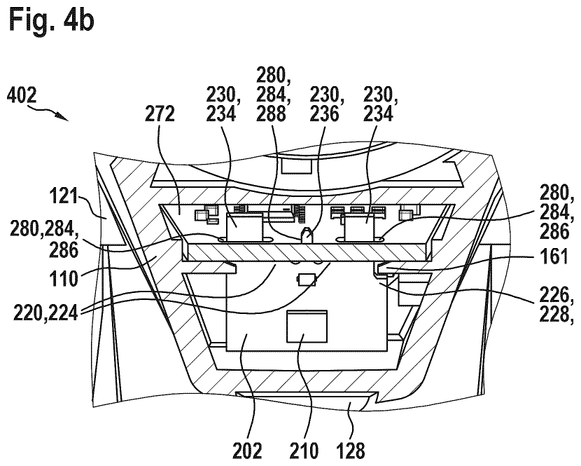

FIG. 4 shows two cross-sectional views of a second embodiment of the control unit 270 with the worksite lighting unit 200 of the hand-held power tool 100 with the cut-out 402 shown. The worksite lighting unit 200, in particular the worksite lighting board 202 and the control unit board 272, are soldered together. By means of example, the abutment element 220 is designed as two abutment webs 224. The abutment webs 224 are integral with the worksite lighting board 202. The two abutment webs 224 are arranged opposite to each other. The light source 210 is substantially arranged between the abutment webs 224. The abutment webs 224 abut the control unit board 272. The control unit board 272 includes three openings 284, 286, 288 as the worksite lighting receptacle 280. Two of the openings 284 are elliptical 286 and one of the openings 284 is circular 288. In the second embodiment, three connecting elements 230 are provided, wherein two of the connecting elements 230 are formed as connecting webs 234 and one of the connecting elements 230 is formed as a connecting mandrel 236. Here, three orientation elements 290 are formed, wherein two of the orientation elements 290 are elliptical 294 and one of the orientation members 290 is circular 296. The orientation elements 290, 294, 296 and the worksite lighting receptacle 280, 284, 246, 288 are integral. The orientation elements 290 arrange the worksite lighting unit 200 transversely to the drive shaft 116. The connecting mandrel 236 is arranged between the two abutment webs 224. In addition, the connecting mandrel is arranged between the two connecting webs 234. Furthermore, a further abutment element 226 is configured here, which is configured as an abutment shoulder 228. The housing 110 has a protrusion 161 to which the abutment shoulder 228 can abut. FIG. 4a shows a front view of the cross-sectional view, with FIG. 4b showing a perspective view of the cross-sectional view.

What is claimed is:

1. A hand-held power tool, comprising:
a housing with an electrically commutated drive motor comprising a drive shaft and substantially arranged within the housing;
a control unit configured to control the drive motor, the control unit comprising a control unit board; and
a worksite lighting unit configured to light a worksite,
wherein
the worksite lighting unit is arranged at an angle to the control unit board.

2. The hand-held power tool according to claim 1, wherein the worksite lighting unit comprises a worksite lighting board arranged at an angle to the control unit board.

3. The hand-held power tool according to claim 1, wherein the worksite lighting unit at least partially abuts the control unit board.

4. The hand-held power tool according to claim 1, wherein the worksite lighting unit comprises at least one abutment element configured to abut the control unit board.

5. The hand-held power tool according to claim 1, wherein the control unit board comprises a worksite lighting receptacle configured to at least partially receive the worksite lighting unit.

6. The hand-held power tool according to claim 1, wherein the worksite lighting unit comprises at least one connecting element configured to connect to the control unit board.

7. The hand-held power tool according to claim 1, wherein the control unit comprises at least one orientation element configured to align the worksite lighting unit relative to the control unit board.

8. The hand-held power tool according to claim 7, wherein the at least one orientation element is configured to arrange the worksite lighting unit transversely to the drive shaft.

9. The hand-held power tool according to claim 7, wherein the at least one orientation element is configured to arrange the worksite lighting unit substantially parallel to the drive shaft.

10. The hand-held power tool according to claim 1, wherein the control unit board is arranged substantially parallel to the drive shaft in the housing.
